(19) United States
(12) Patent Application Publication
(10) Pub. No.: US 2009/0106826 A1
(43) Pub. Date: Apr. 23, 2009

(54) METHOD AND SYSTEM FOR USER AUTHENTICATION USING EVENT TRIGGERED AUTHORIZATION EVENTS

(76) Inventor: Daniel Palestrant, Cambridge, MA (US)

Correspondence Address: LOWRIE, LANDO & ANASTASI, LLP, ONE MAIN STREET, SUITE 1100, CAMBRIDGE, MA, 02142, US

(21) Appl. No.: 11/875,157

(22) Filed: Oct. 19, 2007

(51) Int. Cl. H04L 9/32

(52) U.S. Cl. 726/7

(57) ABSTRACT

According to one aspect of the invention, authorization events trigger authentication requests for a user during the course of a computer session. In one example an authorization event trigger occurs as a user navigates through a web interface. In one embodiment, a user authenticates him or herself to enter a secure site. During the course of navigation through the secure site, authentication events are triggered. Authorization events occur when, for example, the user wishes to perform some action associated with the secure site or provide comment on information obtained from the secure site or obtain information from the secure site. The act of submitting or taking some action comprises a triggering event. In response to a triggered authorization request, a system related to the secure site (or the same system) generates authentication information, in one example, as a one-time password (OTP) that is transmitted to the user. The hardware/software necessary to accomplish the generation of a secure OTP resides with the provider hosting the secure site, although one should appreciate that the OTP generation may be delegated to another site or received as a service from a third party. In one embodiment, the user receives the OTP in the form a page to a pager. With respect to the medical field, a physician may be required to maintain a pager and liability can result from its loss or absence. In one example, such a requirement can be leveraged to provide additional layers of security where patient data is accessible over networks, and in one example over the Internet. Authorization event triggers are also used in conjunction with a system that does not require an authenticated user before reaching the authorization event triggers. Such environments can include a medical services/treatment environment, a financial services environment, and an information brokerage service environment.

### BACKGROUND OF THE INVENTION

The Internet has provided unprecedented access to information and has spawned industries designed to allow better, quicker, and more convenient access to that information. This unprecedented access has come with many costs. By permitting easier access to information, the information itself has become vulnerable. And in many situations significant liability attaches to the loss or compromise of that information. Thus security has become the new watchword of the Internet. Any site that provides access to private information must be secure.

Login names and passwords have been employed in the past to solve this security problem. However, poor choices in login name and password combinations continue to plague the use of login names and passwords as a viable security mechanism. Predictable user names and passwords in the form of children's names, birthdays, or even dictionary words are known points of weakness in any login/password system. Various methods have been employed to improve this system including randomly generated passwords and forced changes to passwords on a periodic basis, for example. However, these improvements are subject to their own set of problems, including users writing down complicated random passwords, changing passwords from one easily guessed password to another. In addition to problems associated with users, the administration of these systems increases dramatically, as users lose and forget passwords. The problems are magnified if the login names are subject to the same requirements.

Other security systems seeks to simplify what is required and at the same time increase security. Two factor authentication methods represent another methodology used to provide for secure authentication. Two Factor authentication typically takes the form of providing something you have and something you know. One example would include ATM transactions. You provide something you have, your ATM card—one factor, and you provide something you know, your password—another factor. Some systems use two factor authentication in conjunction with authentication tokens. Authentication tokens are like the ATM card and can even contain static numbers like an ATM card, however, authentication tokens typically have hardware associated with them that generates a number that changes over time. Only when that periodically changing number matches one on the system you are trying to access, will a user be authenticated, provided the other factor is validated as well. In one example, the hardware token generates a one time password (OTP) on a periodic basis.

Generating periodically changing numbers to establish one factor for authentication can be expensive. Each user requires his or her own token—which often have very specific lives and need to be replaced periodically—and the synchronization between the numbers generated by the token and the numbers generated by the authentication system still pose issues. Both generation methods, the user's and the provider's must be synchronized to generate matching OTPs at the same time. In verifying a user's OTP, the authentication system must also provide for a delay between generation, submission, and receipt/verification, thus causing synchronization issues. Additionally, these hardware tokens are frequently lost and replacing them becomes both expensive and time consuming. Certain systems have sought to maintain the benefit of periodically generated number sequence and eliminate the hardware token requirement, by implementation the generation process in software. Using “soft tokens” the number generation takes place in software installed on a computing device, for example a PC. These systems replace the portable hardware token with another computer based token. Although typically your computing system is harder to lose, the same problems exist where your computing system is portable. And where the computing system is not portable, a user is limited to access at that system.

Providing ease of access while maintaining appropriate levels of security has proven particularly challenging where the information and actions one seeks to protect are particularly sensitive. For example, financial services over the Internet require particular handling to maintain very sensitive banking and account information. Sophisticated login procedures are in place to insure that only an authorized user may log on, view information, and perform transactions. Conventional systems focus their attention on the authorization of a user at entry of the secure system.

Likewise, the medial services field presents another area where the information or actions in question are particularly sensitive. The highly sensitive nature of the information has lead to reluctant adoption of remote computer access to, for example, patient information, services, lab information, among others. However, conventional systems are being implemented to improve access with increased security. For example, two factor authentication has been employed using hardware tokens to provide access to medical information, and enable medical services to be authorized and performed. These conventional system focus on permitting only authorized users to enter a secure system.

### SUMMARY OF INVENTION

By implementing systems or methods for user authentication using event triggered authorization, the present invention overcomes many of the shortcomings of conventional authentication systems. In one example, an authenticated user navigates a secure site having already provided authentication information. The user during the course of navigation triggers a series of authentication events. For example, if the user is a doctor seeking to type notes into a patient's history, the doctor may trigger an authentication event by typing or by selecting submit. The authentication event triggers an additional security layer based on a provider's settings for particularly sensitive information or activities. In the above example, a provider may require a doctor to authenticate in response to an authentication event trigger in order to view a patient's chart. In such a way a service provider is assured only authorized users may access particular functions or information. In the case of doctors, one should appreciate why a particular activity may be of increased sensitivity. Doctors using such a system may be permitted to generate prescriptions, and even where the doctors entry authentication information (of whatever form) has been compromised, the act of trying to write a script triggers an authorization event that prevents an inappropriately authorized user from performing the selected activity. In addition, failure to properly authenticate in response to an authentication event may trigger revocation of the compromised user account, minimizing the impact of compromised authentication information.

In one embodiment, a doctor may trigger an authentication event after reviewing a patient's chart and determining a prescription is called for. By entering information relating to a prescription the doctor triggers an authentication event that must be resolved before the activity can take place. The authorization event causes the provider's system or another secure system associated with the provider to generate authorization information, which may be in the form of an One Time Password (OTP), that is transmitted directly to the authorized user via a page to a pager. The use of a pager provides significant benefits when used in the medical field, and in particular with doctors. Doctors may be required to carry pagers in the course of their duties. The loss of pager may result in liability on the part of the doctor, thus reliance may be placed, in part, on a particular doctor to take care in maintaining possession of the authorized pager. Liability insures that the device will remain with the authorized user, and in this case doctor. Generating OTP on systems not maintained by the user and then sending the OTP to them provides many advantages. One example, is the reduction in the need of expensive hardware to generate OTPs. In both hard token systems (hardware based tokens) and soft token systems (software based tokens) each user requires their own implementation of the hardware or software, multiplying costs for every user on a particular system. Generating authentication information, and in this example OTPs, on the back-end and transmitting them, requires only one generation system and a transmission medium, which in the case of pagers and paging is rather inexpensive. Other transmission systems can be employed and still leverage the reduce complexity of the provider controlled authorization information generation.

According to one aspect of an embodiment, as the provider controls the generation system, synchronization between transmitted authorization information and submitted authorization information becomes easier to manage. The timing of, for example, OTP generation and subsequent receipt by the authorization system can be monitored, and specifically accounted for by the provider because the provider can control the time involved in generating and transmitting OTPs. Similar benefits can be achieved even where the provider employs a third party to generate authorization information.

According to another aspect of an embodiment, transmission of authorization information provides for the implementation of a feedback mechanism designed to identify and mitigate compromised authentication information. Authorized users can report the receipt of transmitted authorization information. Notably, where an authorized user has not performed any activity that would trigger an authorization event, and consequently the transmission of authorization information, the authorized user is immediately aware of unauthorized activity. The authorized user can report the receipt of authorization information and the provider can take appropriate measures that may include, de-activating any authentication information associated with that particular user (e.g. the user account), terminate the session associated with the authorized user, log all unauthorized access, flag the logs for security review, trace back the unauthorized access to its source, divert the unauthorized user to dummy pages designed to track and identify the unauthorized user, report unauthorized activity to a security department for appropriate action, and install application objects on the unauthorized users computer system in order to perform various mitigation functions.

According to another aspect of one embodiment, a feedback mechanism is not necessary to trigger the above described actions. The failure to authenticate in response to authentication event triggers may trigger the same responses described above with respect to the feedback mechanism on the part of the provider or a security department associated with the provider.

According to another aspect of an embodiment, particular systems, including an Information Brokerage Environment are well suited to the use of authorization event triggers to secure activity and information. An example of an Information Brokerage Environment (“IBE”) provides for its user population to submit and share original ideas, and use collective knowledge to advantageously arrive a predictions and observations. In one example, a user of an IBE system will submit an idea in the form of a ticket. The ticket will contain a concept that will be commented on by the user population of the IBE. The ticket may be associated with a future event, and the user population may vote on how they believe such an event will unfold. The voting may come in the form of bidding, similar to the operation of a stock exchange. Results of these tickets are tracked and users may be score don how well they performed in terms of their predictive power (how soon they got the correct result, how often they correctly predict, etc.) and also in terms of their social power (how their opinion impacts others, the size of any peer group they belong to, and other social networking characteristics). Co-pending application Ser. No. 11/482,523 Method and Apparatus For Conducting An Information Brokering Service discusses many features of such an Environment and is herein incorporated by reference.

As discussed, certain functions in an IBE relate to the reputation of a particular user. In the context of some IBEs, reputation scores serve to assist in driving the system and provide a value to the users themselves. Reputational related activity (comments submitted on ideas, particular votes for particular predictions) can be protected using authorization event triggers, for example when a user attempt to submit a ticket, an authorization event can be triggered and in order to proceed the user must enter the transmitted authorization information correctly. To avoid overly burdening a particular user with authorization events, a time window may be applied to authorization event triggers. For example, once a user has properly submitted the transmitted authorization information, that event may be associated with a timer, and management of additional authorization event triggers will include logic to check the associated timer. Where the user has already validated him or herself against an authorization event within a defined time the authorization event may be deemed validated, or not be executed.

According to another embodiment, an environment that provides Medical Treatment/Services is well suited to the use of authorization event triggers to authenticate user access to content and user activities performed in the environment. Doctors and medical staff may be provided with secure access to patient information, patient histories, patient charts, and specific activities related to patient care can be associated with authorization event triggers. For example, viewing a patient's history may trigger and authentication event, where authorization information is transmitted to a liability insured device associated with the user. In order to view the information, the user must submit the received authorization information which must be validated against the generated authorization information. According to another example, commenting or inserting notes into the patients history may be associated with authorization event triggers. And the user will have to submit the received authorization information for validation in order to proceed. Optionally, a time window may be associated with the authorization event triggers, so that if a user has already been validated against an authorization event, subsequent authorization event triggers will be deemed validated or ignored. In the case of medical professionals, such a window would typically be of very short duration, and certain operations/activities can not be excluded or deemed validated. In one example, the act of writing a prescription for a patient may be configured to always require validation of transmitted authorization information regardless of any time window. Activities associated with the physical care of a patient may also be so configured (discharge order, requesting lab work for a patient, etc.). It should be appreciated that the provider of such an environment can establish various criteria for the authorization event triggers and the preceding examples should not be read as limiting the criteria to any one particular implementation.

According to another embodiment, an environment providing financial services employs authorization event triggers to authenticate user access to content and user activities performed in the environment. The same benefits discussed above can be achieved in a financial services environment. In particular, activities related to making payments, transferring funds, etc., can be associated with authorization event triggers. Virtually any service provided by a financial service environment can be associated with an authorization event trigger.

According to one aspect of the present invention, a method for authentication of a user employing triggers for authorization events is provided. The method comprises providing a secure environment for a user to access, permitting the user to access the secure environment in response to the user submitting authentication information, providing for the authenticated user to navigate within the secure environment, establishing at least one authorization event trigger that generates an authentication request in the secure environment, providing for generation of authentication information in response to an authorization event trigger, providing for transmission of the authentication information to a device associated with the user; and providing for verification of submitted authentication information. According to one embodiment of the present invention, the act of providing for transmission of the authentication information comprises providing for transmission of the authentication information over a paging network. According to another embodiment of the invention, the act of providing for transmission of the authentication information comprises transmitting the authentication information as a page to a pager. According to another embodiment of the invention, the device associated with the user is a liability insured device. According to another embodiment of the invention, the at least one authorization event trigger comprises a content trigger.

According to one embodiment of the present invention, the at least one trigger comprises a activity trigger. According to another embodiment of the invention, the act of establishing at least one authorization event trigger further comprises defining at least one of an activity and content associated with the secure environment. According to another embodiment of the invention, the at least one of an activity and content associated with the secure environment comprises at least one of private information of a third party, licensed activity, reputational related activity, opinion information, reputation information, voting, ticket generation, notating records, and bidding. According to another embodiment of the invention, defining at least one of an activity and content associated with the secure environment is based on at least one of an information privacy law, a contractually established information privacy obligation, an obligation related to public safety, a liability of the provider, and a high value transaction. According to another embodiment of the invention, the method further comprises an act of providing a feedback mechanism for an authorized user.

According to one embodiment of the present invention, the method further comprises an act of deactivating access to the secure site in response to the authorized user submitting feedback. According to another embodiment of the invention, the method further comprises an act of deactivating access to the secure site in response to a failure to provide valid authentication information in response to an authorization event. According to another embodiment of the invention, the method further comprises an act of tracking unauthorized access by tracking at least one of keystroke activity of the unauthorized user, communication protocol information generated between unauthorized user and the secure environment, and redirecting unauthorized user to dummy pages that trace unauthorized access. In another embodiment, authorization event triggers are activated in response to a user navigating the secure site.

According to one aspect of the present invention, in an information brokering service environment, a method for authentication of a user employing triggers for authorization events is provided. The method comprises providing for the user to navigate the information brokering service environment, establishing at least one authorization event trigger that generates an authentication request associated with the information brokering service environment, providing for generation of authentication information in response to an authorization event trigger, providing for transmission of the authentication information to a device associated with a user, and providing for the verification of user submitted authentication information against the generated authentication information. According to one embodiment of the present invention, the act of providing for transmission of the authentication information comprises providing for transmission of the authentication information over a paging network. According to another embodiment of the invention, the act of providing for transmission of the authentication information comprises transmitting the authentication information as a page to a pager. According to another embodiment of the invention, the device associated with the user is a liability insured device. According to another embodiment of the invention, the at least one authorization event trigger comprises a content trigger.

According to one embodiment of the present invention, the at least one trigger comprises an activity trigger. According to another embodiment of the invention, the act of establishing at least one authorization event trigger further comprises defining at least one of activity and content associated with the information brokering service environment. According to another embodiment of the invention, the at least one of activity and content associated with the information brokering service environment comprises at least one of private information of a third party, licensed activity, reputational related activity, opinion information, reputation information, voting, ticket generation, notating records, and bidding. According to another embodiment of the invention, defining at least one of activity and content associated with the information brokering service is based on at least one of an information privacy law, a contractually established information privacy obligation, an obligation related to public safety, a liability of the provider, and a high value transaction. According to another embodiment of the invention, the method further comprises an act of providing a feedback mechanism for an authorized user. According to another embodiment of the invention, the method further comprises an act of deactivating access to the information brokering service site in response to the authorized user submitting feedback. According to another embodiment of the invention, the method further comprises an act of deactivating access to the information brokering service site in response to a failure to provide valid authentication information in response to an authorization event. According to another embodiment of the invention, the method further comprises an act of tracking unauthorized access by tracking at least one of keystroke activity of the unauthorized user, communication protocol information generated between unauthorized user and the information brokering environment, and redirecting unauthorized user to trace unauthorized access. In another embodiment, authorization event triggers are activated in response to a user navigating the information brokering service site.

According to one aspect of the present invention, in a medical services and treatment environment, a method for authentication of a user employing triggers for authorization events is provided. The method comprises providing for the user to navigate the medical services and treatment environment, establishing at least one authorization event trigger that generates an authentication request associated with the medical services and treatment environment, providing for generation of authentication information in response to an authorization event trigger, providing for transmission of the authentication information to a device associated with a user, and providing for the verification of user submitted authentication information. According to one embodiment of the present invention, the device is a liability insured device. According to another embodiment of the invention, the at least one authorization event trigger that generates authentication requests associated with medical services and treatment environment occurs in response to the user navigating the site. According to another embodiment of the invention, the act of providing for transmission of the authentication information comprises providing for transmission of the authentication information over a paging network. According to another embodiment of the invention, the act of providing for transmission of the authentication information comprises transmitting the authentication information as a page to a pager. According to another embodiment of the invention, the device associated with the user is a liability insured device.

According to one embodiment of the present invention, the at least one authorization event trigger comprises a content trigger. According to another embodiment of the invention, the at least one trigger comprises a activity trigger. According to another embodiment of the invention, the act of establishing at least one authorization event trigger further comprises defining at least one of an activity and content associated with the medical services and treatment environment. According to another embodiment of the invention, the at least one of an activity and content associated with the medical services and treatment environment comprises at least one of private information of a third party, licensed activity, reputational related activity, opinion information, reputation information, voting, ticket generation, notating records, and bidding. According to another embodiment of the invention, defining at least one of an activity and content associated with the medical services and treatment environment is based on at least one of an information privacy law, a contractually established information privacy obligation, an obligation related to public safety, a liability of the provider, and a high value transaction. According to another embodiment of the invention, the method further comprises an act of providing a feedback mechanism for an authorized user. According to another embodiment of the invention, the method further comprises an act of deactivating access to the site in response to the authorized user submitting feedback. According to another embodiment of the invention, the method further comprises an act of deactivating access to the site in response to a failure to provide valid authentication information in response to an authorization event. According to yet another embodiment of the invention, the method further comprises an act of tracking unauthorized access by tracking at least one of keystroke activity of the unauthorized user, communication protocol information generated between unauthorized user and the medical services and treatment environment, and redirecting unauthorized user to trace unauthorized access. In another embodiment, authorization event triggers are activated in response to a user navigating the medical services and treatment site.

According to one aspect of the present invention, a system for authentication of a user employing triggers for authorization events is provided. The system comprises an authentication component adapted to provide a secure environment for a user, an interface adapted to permit the authenticated user to navigate within the secure environment, an authorization controller adapted to execute at least one authorization event trigger in response to the authenticated user navigating the secure site, an authorization information generation component for generation of authentication information, a communication component for transmission of the authentication information to a device associated with the user, and a verification component for verification of submitted authentication information. According to one embodiment of the present invention, the transmission component is further adapted to provide for transmission of the authentication information over a paging network. According to another embodiment of the invention, the transmission component is further adapted to transmit the authentication information as a page to a pager. According to another embodiment of the invention, the device associated with the user is a liability insured device. According to another embodiment of the invention, the at least one authorization event trigger comprises a content trigger.

According to one embodiment of the present invention, the at least one trigger comprises a activity trigger. According to another embodiment of the invention, the authorization controller is further adapted to associate an authorization event trigger with at least one of an activity and content associated with the secure environment. According to another embodiment of the invention, the at least one of an activity and content associated with the secure environment comprises at least one of private information of a third party, licensed activity, reputational related activity, opinion information, reputation information, voting, ticket generation, notating records, and bidding. According to another embodiment of the invention, defining at least one of an activity and content associated with the secure environment is based on at least one of an information privacy law, a contractually established information privacy obligation, an obligation related to public safety, a liability of the provider, and a high value transaction. According to another embodiment of the invention, the system further comprises a feedback component for an authorized user.

According to one embodiment of the present invention, the feedback component is further adapted to deactivate access to the secure site in response to the authorized user submitting feedback. According to another embodiment of the invention, the feedback component is further adapted to deactivate access to the secure site in response to a failure to provide valid authentication information in response to an authorization event. According to another embodiment of the invention, the system further comprises a tracking component for tracking unauthorized access by tracking at least one of keystroke activity of the unauthorized user, communication protocol information generated between unauthorized user and the secure environment, and redirecting unauthorized user to trace unauthorized access.

According to one aspect of the present invention, in an information brokering service environment, a system for authentication of a user employing triggers for authorization events is provided. The system comprises an interface adapted to permit the user to navigate within the information brokering service environment, an authorization controller adapted to execute at least one authorization event trigger in response to the authenticated user navigating the information brokering service site, an authorization information generation component for generation of authentication information, a communication component for transmission of the authentication information to a device associated with the user, and a verification component for verification of submitted authentication information.

According to one aspect of the present invention, in a medical services and treatment environment, a system for authentication of a user employing triggers for authorization events is provided. The system comprises an interface adapted to permit the user to navigate within the medical services and treatment environment, an authorization controller adapted to execute at least one authorization event trigger in response to the authenticated user navigating the medical services and treatment site, an authorization information generation component for generation of authentication information, a communication component for transmission of the authentication information to a device associated with the user, and a verification component for verification of submitted authentication information.

According to one aspect of the present invention, a computer-readable medium having computer-readable signals stored thereon that define instructions that, as a result of being executed by a computer, instruct the computer to perform a method for authentication of a user employing triggers for authorization events is provided. The method comprises providing a secure environment for a user to access, permitting the user to access the secure environment in response to the user submitting authentication information, providing for the authenticated user to navigate within the secure environment, establishing at least one authorization event trigger that generates an authentication request in the secure environment, providing for generation of authentication information in response to an authorization event trigger, providing for transmission of the authentication information to a device associated with the user; and providing for verification of submitted authentication information. Various embodiments of the computer-readable medium incorporate the elements discussed above with respect to the method alone.

According to one aspect of the present invention, in an information brokering service environment, a computer-readable medium having computer-readable signals stored thereon that define instructions that, as a result of being executed by a computer, instruct the computer to perform a method for authentication of a user employing triggers for authorization events is provided. The method comprises providing for the user to navigate the information brokering service environment, establishing at least one authorization event trigger that generates an authentication request associated with the information brokering service environment, providing for generation of authentication information in response to an authorization event trigger, providing for transmission of the authentication information to a device associated with a user, and providing for the verification of user submitted authentication information against the generated authentication information. Various embodiments of the computer-readable medium incorporate the elements discussed above with respect to the method alone.

According to one aspect of the present invention, in a medical services and treatment environment, a computer-readable medium having computer-readable signals stored thereon that define instructions that, as a result of being executed by a computer, instruct the computer to perform a method for authentication of a user employing triggers for authorization events is provided. The method comprises providing for the user to navigate the medical services and treatment environment, establishing at least one authorization event trigger that generates an authentication request associated with the medical services and treatment environment, providing for generation of authentication information in response to an authorization event trigger, providing for transmission of the authentication information to a device associated with a user, and providing for the verification of user submitted authentication information. Various embodiments of the computer-readable medium incorporate the elements discussed above with respect to the method alone.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings,

FIG. 1 is a flow diagram illustrating an embodiment of an authentication process including the use of authorization event triggers to authenticate a user for a particular activity or access to content;

FIG. 2 is a flow diagram illustrating an embodiment of an authentication process including a feedback mechanism for reporting unauthorized access;

FIG. 3 is a flow diagram illustrating an embodiment of an authentication process in an information brokerage service environment including authorization event triggers;

FIGS. 4A-B illustrate the presentation of content triggers and activity triggers within a navigation window;

FIG. 5 illustrates an interface for a feedback mechanism according to one aspect of the invention;

FIG. 6 is a top view of a pager for receiving authorization information transmitted in response to an authorization event trigger;

FIG. 7 is a block diagram of a system for user authentication according to one embodiment of the present invention;

FIG. 8 is a block diagram of a system for user authentication according to one embodiment of the present invention; and

FIG. 9 is a block diagram of a system for user authentication according to one embodiment of the present invention.

The figures are presented by means of illustration and are not meant to be limiting.

### DETAILED DESCRIPTION

According to one aspect of the invention, events trigger authentication requests for a user during the course of a computer session. In one example an event trigger may occur as a user navigates through a web interface. Typically, a user must authenticate him or herself to enter a secure site. During the course of navigation through the secure site authentication events are triggered. For example the user may wish to perform some action associated with the secure site or provide comment on information obtained from the secure site. The act of submitting or taking an action may be the triggering event. In response to an event triggered authorization request, a system related to the secure site will generate authentication information, in one example as a one-time password (OTP) that is transmitted to the already authenticated user. The hardware/software necessary to accomplish the generation of a secure OTP resides with the provider hosting the secure site, although one should appreciate that the OTP generation may be delegated to another site or received as a service from a third party. In one embodiment, the user receives the OTP in the form a page to a pager. With respect to the medical field, a physician may be required to maintain a pager and liability can result from its loss or absence. This requirement can be leveraged to provide additional layers of security where patient data is accessible over networks, and in one example over the Internet.

Authorization event triggers can be established by the provider of the secure site, and in the case of the medical field, may be related to specific actions a physician wishes to perform. In particular, an already authenticated doctor can be required to submit a “third factor” of authorization in order to submit a prescription for a particular patient, or to post notes to a patient's file. Various forms of primary authentication are used in conventional methodologies. One form involves two factor authentication. In one aspect of the invention, such conventional technologies are enhanced with a third factor of authentication. Under conventional methodologies the use of a pager and a OTP transmission for an already authenticated user would be a third and forth factor of authentication. Reference to a “third factor” or authentication is meant to encompass both a third factor alone and a third and forth factor used in combination, or with any additional number of authentication criteria.

According to one aspect of the present invention an already secure site, that employs conventional security techniques (for ex. two-factor authentication) is made more secure by incorporating authorization event triggers related to specific activities a user wishes to take while navigating a particular web-site, web-portal, or private network access. The authorization event triggers may be associated with particularly sensitive events, as described in relation to the health services fields—prescription writing, patient file edits, accessing patient records, ordering tests, submitting discharge orders, and may include other tasks associated with patient care that typically require a health care professional to “sign off” on an activity. In other fields, for example, the financial services field an already authenticated user may be able to access bank account information, but in order to transfer money from one account to another, the user triggers an authentication event and must satisfy the authentication request in order for the transaction to be completed. Only in response to valid authentication in response to the authentication event will the transactions occur. Additionally, access to a secure site may be revoked on the basis of failure to compete authorization in response to an authentication event.

According to one aspect, the added layer of security for sensitive events provides significant advantage where some authentication information has been comprised. Where a malicious user has gained access improperly to a secure site, the triggering of an authentication event will notify first the proper user of the account that an authorization event has been triggered. The proper user will know immediately that unauthorized access is in fact taking place. Optionally, the proper user may reply to the sending of the authentication information (for example an OTP) indicating that unauthorized access is occurring. In response to the reply—account access would be terminated and logs of the entire session may be preserved. Alternatively, tracing may be performed on the malicious user redirecting unauthorized access to holding pages designed to trace-back ip addresses, and otherwise identify the source of the unauthorized access.

Even where the proper user does not respond to the transmission of the OTP in response to the authentication event, a time-out may be associated with each event triggered authorization request. Multiple failures to provide the OTP in response to the event triggered authorization request may also cause suspension of a user account, logging of the entire user session, trace attempt, and review by IT security to determine what activity transpired during the session.

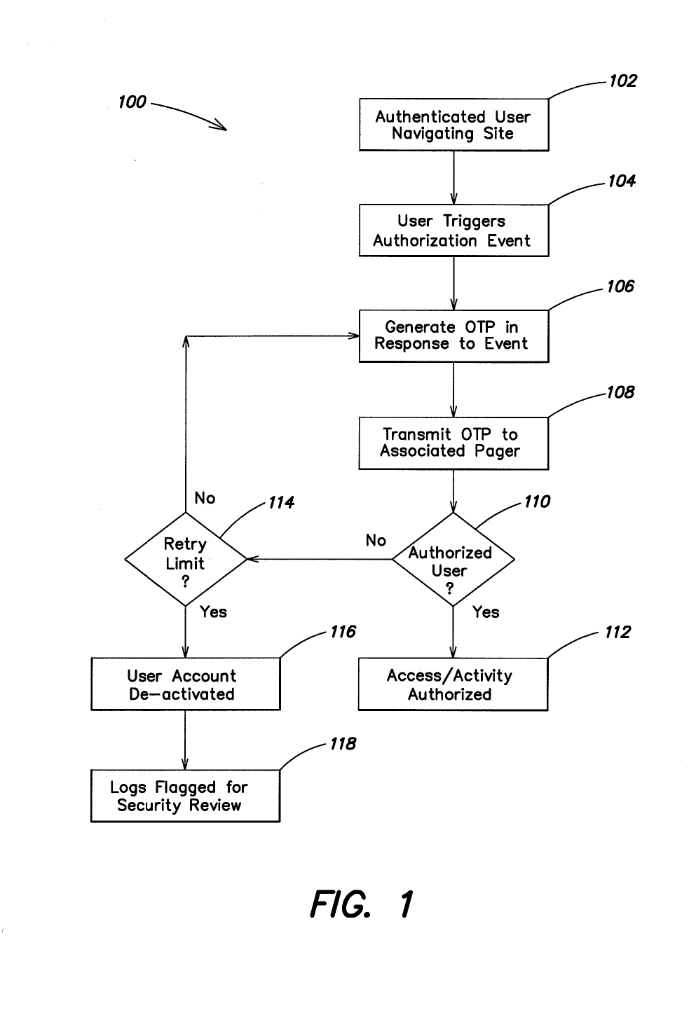

With reference to FIG. 1, an embodiment of a process 100 is shown. Process 100 describes an embodiment of a method for authenticating a user using event triggers to generate authentication requests.

In step 102, an authenticated user navigates a secure site, portal, or other electronic information distribution mechanism. In order to navigate the secure site the user has already been authenticated by at least one form of authentication. In one example, the user has submitted a user name and password in order to gain access to the secure site. Having gained access the secure site the user is permitted to navigate its content. The content may be in the form of text, links, radio buttons, submit buttons, images, etc. As is known in the art the various images, links, text, etc. may be used by the site provider to direct the user to another page within the site. For example, a submit button in association with a text box enables a user to input suggestions and submit them to the secure site. In another example, a user navigates to additional content pages by clicking on a link or image within a page.

At step 104, the navigating user triggers an authorization event by attempting to access content associated with an authorization trigger. Alternatively, the user triggers an authorization event at step 104, by attempting to perform a particular activity (submit comment, vote, bid, etc.). In one embodiment, a doctor is the authorized user and the authorization event trigger is an attempt to access a patient's chart and/or history. In another embodiment, an authorization event trigger is linked to notating a patient's chart or prescribing medication for the patient. One should appreciate that the provider of the secure site which the user is accessing is permitted to define event triggers for virtually any activity and content access request for a particular site. In one embodiment where the user is a doctor or physician, submission of opinions regarding drug trials are linked to an authorization event. One should appreciate that there may be multiple triggers linked to multiple events.

According to one embodiment, trigger(s) are linked to the submission of a vote predicting the result of such a trial. In another embodiment trigger(s) are linked to a number of activities that a licensed medical professional is able to perform with respect to patients, including discharge, writing prescriptions, diagnosing, notating charts, requesting labs, reviewing labs results, etc.

Once an authorization event has been triggered, authentication information is generated in response, at step 106. The authentication information may take the form of an OTP (One Time Password) or may be in the form of another authorization schema. The system for generating the authentication information may be the same system that hosts the secure site, or may be another system associated with the secure site, or can be contracted out to a third party associated with provider of the secure site.

Once the authorization information is generated (in one example as an OTP), the OTP is transmitted to an device associated with the authorized user. At step 108, the OTP is transmitted to a pager associated with the authorized user in the form of a page. At step 110, the user enters the received OTP, and the system determines if the submitted OTP matches the generated OTP. Optionally, in order to validate the submitted and generated OTP, the system may require that the user enter the OTP within a specific time window. In the event that the user fails to enter the OTP correctly 110(NO) or does not do so within the required window, the system will determine if the user has failed to properly validate in excess of a system defined threshold at step 114. In one example, the threshold will allow a user to attempt to validate the received OTP against the generated OTP three times, and upon the third failure, step 114(YES), the user's account will de-activated at step 116. If the retry limit has not been reached, 114(NO), the system will optionally generate a new OTP at 106, transmit it to the user associated device at 108, and validate the submitted OTP against the generated OTP at 110. Alternatively (not shown), the user may be prompted to re-enter the transmitted OTP without requiring the generation of a new OTP, and the resubmitted OTP will be validated against the generated OTP again at step 110.

Where the generated OTP and the submitted OTP match, and optionally where the OTP is also submitted in the appropriate time frame, step 110(YES), the user is authorized to gain access to the requested content or the user is authorized to perform the requested activity, at step 112.

As an additional security feature, entire user sessions may be logged by the secure site. In the event a user has failed to properly authenticate in response to the authorization event and the user has exceeded the retry limit 114(YES), the user account will be de-activated, and the session logs may be flagged for review at step 118. In one embodiment, step 118 includes active measures designed to trace back the unauthorized activity to a person or a computer system accessing the secure site. These active measures may come in the form of redirecting the unauthorized user to dummy pages meant to maintain the connection between the unauthorized user and the secure site in order to perform trace back analysis or procedures. According to one aspect, the active measure may include transmitting an object to the unauthorized user, such that the object will transmit from the unauthorized user's computer accurate tracking information to the provider of the secure site.

It should be appreciated that process 100, may be repeated for multiple authorization events contained within a particular environment. An optional feature associated with multiple authorization event triggers (not shown), includes the use of a time window. According to one embodiment, the time window is configured by the provider of an environment, and set to a predetermined length. The time window defines a period of time during which the system ignores subsequent authorization event triggers or deems them validated, as the user has recently validated him or herself against transmitted authorization information. In an implementation with a time window, authorization event triggers may be further configured to require validation regardless of the time window. The provider of the environment can establish almost any specific criteria for authorization event triggers, including those specifically discussed but not excluding those not specifically enumerated, unless explicitly stating a feature is excluded.

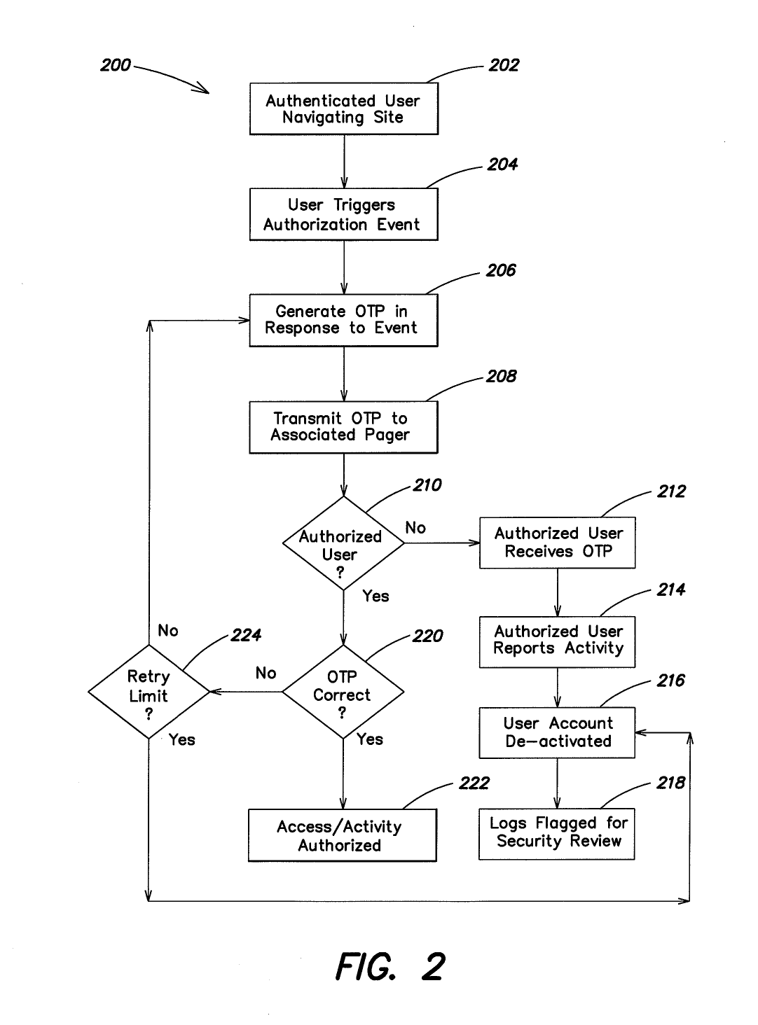

With reference to FIG. 2, an embodiment of a process 200 is shown. Process 200 describes an embodiment of a method for authenticating a user using event triggers to generate authentication requests and includes a feedback mechanism for authorized users to report unauthorized access.

In step 202, an authenticated user navigates a secure site, portal, or other electronic information distribution mechanism. In one example, the user has submitted a user name and password in order to gain access to the secure site, however other forms of authentication may be used to access the secure site. Having gained access the secure site the user is permitted to navigate its content. The content may be in the form of text, links, radio buttons, submit buttons, images, etc. As is known in the art, the various images, links, text, etc. may be used by the site provider to direct the user to another page within the site. For example, a submit button in association with a text box may enable a user to input suggestions and submit them to the secure site. Or in another example, a user navigates to additional content pages by clicking on a link or image within a page.

At step 204, the navigating user triggers an authorization event by attempting to access content associated with an authorization trigger. Alternatively, the user may trigger an authorization event at step 204, by attempting to perform a particular activity (submit comment, vote, bid, etc.). In one embodiment, a doctor is the authorized user and the authorization event trigger is an attempt to access a patient's chart and/or history. In another embodiment, an authorization event trigger is linked to notating a patient's chart or prescribing medication for the patient. One should appreciate that the provider of the secure site which the user is accessing can define event triggers for virtually any activity and content access request for a particular site. Such activities or content requests may include submission of opinions, voting, bidding, submission of a ticket, licensed activity, licensed activity in association with patient care (discharge, writing prescriptions, diagnosing, notating charts, requesting labs, reviewing labs results, etc.), and may include reputational related activity.

Once an authorization event has been triggered, authentication information is generated, at step 206. In one embodiment, the authentication information takes the form of an OTP (One Time Password) but one should appreciate that authentication may be in the form of another authorization schema or system. The system for generating the authentication information may be the same system that hosts the secure site, or in one alternative is another system associated with the secure site, or in another alternative is contracted out to a third party associated with provider of the secure site.

Once the authorization information is generated (in one example as an OTP), the OTP is transmitted to an device associated with the authorized user. At step 208, the OTP is transmitted to a pager associated with the authorized user in the form of a pager. At step 210, it is ascertainable whether the access to the secure site is in fact by an authorized user or whether an unauthorized user has obtained access improperly. At 210(NO), where the access is improper, the authorized user receives transmitted authorization information, at step 212. One should appreciate that the authorized user will immediately recognize that unauthorized access is taking place. The authorized user then reports such access at step 214. Various reporting mechanisms are employed. Where the device associated with the user, is a two-way pager, a reply option may be included with the transmitted authorization information. By hitting the reply button on the pager, the authorized user reports the unauthorized activity and appropriate security measures can be taken. Security measure can include de-activating the user account, at step 216. In one embodiment, step 216 includes active measures designed to trace back the unauthorized activity to a person or a computer system accessing the secure site. These active measures may come in the form of redirecting the unauthorized user to dummy pages meant to maintain the connection between the unauthorized user and the site in order to perform trace back analysis or procedures.

According to one aspect, the active measures include transmitting an object to the unauthorized user, such that the object will transmit from the unauthorized user's computer accurate tracking information to the provider of the secure site. The object may also be configured to perform other operations on the unauthorized user's computer in order to mitigate the unauthorized access. At step 218, logs of the unauthorized session are flagged for security review, and additional optional measures are taken to mitigate the impact of any unauthorized access.

At step 210(YES), an authorized user receives the transmission of the authorization information. The authorized user submits the authorization information and the system validates against the generated authorization information at step 220. At step 220(YES) the authorization information is properly validated and the user access/activity request is permitted.

At step 220(NO), the submitted authorization information is not validated against the generated authorization information. The failure may occur as result of a mis-keyed entry or may be result of the user not entering the authorization information in a specific time frame. At step 224, a test is performed to determine if the user has exceed a retry limit for entry of the proper authentication information. If the user has not exceeded the retry limit 224(NO), new authorization information is generated at step 206 and transmitted to the user associated device at 208. As one alternative, the user is given additional opportunities to re-enter the transmitted authorization information before new authorization information is generated and transmitted. A provider of the environment or site is permitted to configure the retry threshold as desired and is able to set retry limits that may or may not provide additional opportunities to a user to enter transmitted authentication information.

At step 224(YES), the user has failed to enter the transmitted authorization information properly and has exceed the retry limit. In one embodiment, this triggers the de-activation of the user's account at step 216, and in one alternative includes the security measures discussed above, in addition to the flagging of the session logs for security review at step 218. Additionally, step 216 may be reached by the expiration of a timer associated with an authorization event (not shown). Where a user (authorized or not) does not enter anything in response to an authorization event, the timer expires and the expired timer will be treated as failed validation and/or a report of unauthorized activity.

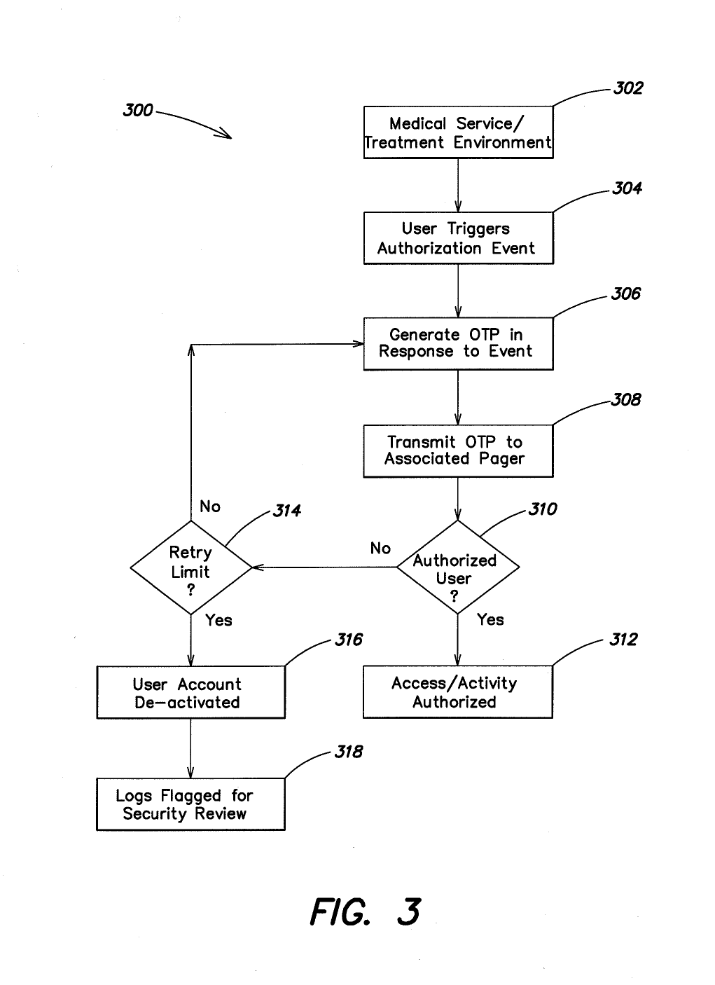

With reference to FIG. 3, an exemplary process 300 is shown. Process 300 describes the use of a method for authenticating a user using event triggers to generate authentication requests for a medical services and treatment environment. Optionally, process 300 may be implemented with a feedback mechanism.

At step 302 a user accesses a medical services/treatment environment. The environment is established by a provider, who determined what services and content the environment will provide. Examples of services and content include access to patient records and information, access to laboratory reports, patient histories, treatment options, prior treatments and/or surgeries, prescription writing, ordering laboratory testing (x-rays, blood work, and the like), submission of discharge orders, submission of admission orders, among others. In the context of the medical services/treatment environment, the user may obtain access through a secure site or an un-secured site as established by the provider. Typically, in the an un-secured environment the user will not have access to private health information nor access to treatment related activities, however the user will have access to links and or web content that will direct the user to private health information and treatment related activities.

At step 304, the user's navigation triggers an authorization event, for example the user attempts to access a patient's history. The environment provider is permitted to define authorization event triggers associated with virtually any activity or request for content associated with the medical services/treatment environment. For example authorization event triggers are defined in conjunction with the type of user—i.e. doctor, nurse, physician's assistant, emergency medical technician, paramedic, administrative staff, etc—in one alternative are defined in conjunction with specific content—private health information, doctor's notes, diagnoses, laboratory reports, etc.—and in another are defined by the requested activity—prescription writing, laboratory testing, discharge order, admission order, submitting diagnoses, etc. Optionally, the environment provider defines mandatory authorization event triggers, ones that can not be overridden by other features of the environment.

In one example, a time window may be associated with an authorization event trigger, and if the user has already successfully responded to an authorization event recently, the subsequent authorization event is ignored and/or deemed validated, such would not be the case with mandatory authorization event triggers. One should appreciate that mandatory triggers would be beneficial with respect to prescription writing and activities related to treatment of a patient, however, mandatory status is not limited to those events.

At step 306, authorization information is generated in response to the authorization event trigger. In one example, the authorization information is generated by a system controlled by the environment provider, which also transmits the authorization information. Alternatively, the provider may be associated with a third party for such generation and/or for the transmission of the generated authentication information, at step 308. According to one embodiment, the authorization information is generated in the form of an OTP at 306 and is transmitted to a pager associated with the user, at 308. Where the user is a doctor, the doctor may be subject to liability for the loosing or misplacing his or her pager, thus proper maintenance of the device itself is insured by external liability. Such external liability may also be imposed by contract, where the user is not a doctor, physician, or physician assistant, or another medical profession who is not subject to liability for loosing any particular communication device.

The user then enters the received authorization information which is verified against the generated authorization information at step 310. At 310(YES) the submitted authorization information is validated and the requested access or activity is permitted. At 310(NO) the authorization information is not validated and the user is prompted to re-enter the authorization information, at step 314 a test is made to determine if the user has exceeded a retry limit. The retry limit may be established by the environment provider at any value deemed appropriate, typically less than three. At 314(NO) new authorization information is generated (step 306) and transmitted to the user associated device (step 308). AT step 314(YES) the user has exceeded the retry threshold and the user account is de-activated at step 316.

In the event of failure to authenticate in response to an authentication event, the user's access may be deemed unauthorized and step 316 may also include active measures designed to trace back the unauthorized activity to a person or a computer system accessing the medical service/treatment environment. In one embodiment, these active measures come in the form of redirecting the unauthorized user to dummy pages meant to maintain the connection between the unauthorized user and the site in order to perform trace back analysis or procedures. According to one aspect, the active measures include transmitting an object to the unauthorized user, such that the object will transmit from the unauthorized user's computer accurate tracking information to the provider of the medical service/treatment environment. The object may also be configured to perform other operations on the unauthorized user's computer in order to mitigate the unauthorized access. At step 318, logs of the unauthorized session are flagged for security review, and additional measures may be taken to mitigate the impact of any unauthorized access.

In one embodiment, process 300 is implemented with respect to an information brokerage service environment. The authorization event triggers are associated with the content provided with respect to an information brokerage service environment, for example ticket generation, voting on tickets, bidding on tickets, submitting comments, various reputational related activity among others.

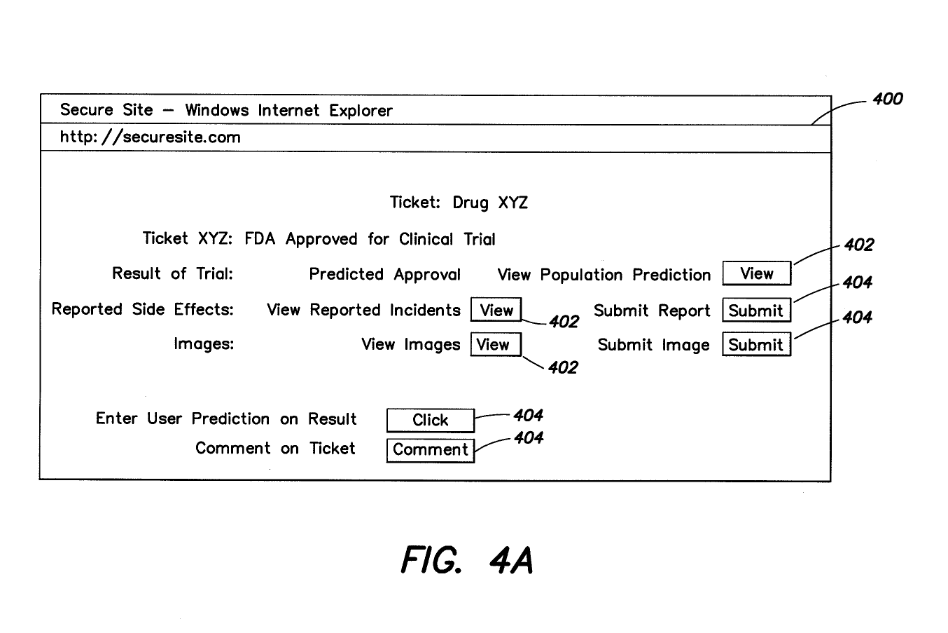

With respect to FIG. 4A, a design for an embodiment of a web page interface is shown, including content and activities selections associated with authorization event triggers. Page 400, describes a view of the page through a browser program. Such browsers programs can include MicroSoft's Internet Explorer, Mozilla, FireFox, NetScape Navigator, and any other browser program designed to render graphical representations of Internet content. Page 400, shows a secure web-site that displays content to a user. A user navigates to page 400, by clicking on links associated with accessing content and by clicking on links associated with performing activities. Although one should appreciate there are a number of ways a user can navigate through a site and many ways for a user to access content or activities without “clicking.” As shown 402, represents authorization event triggers associated with content—content triggers, and 404 represents authorization event triggers associated with an activity—activity triggers. With respect to FIG. 4B, shown is an embodiment of a web-page 450 that is implemented using AJAX. Again content triggers 402 and activity triggers 404 will require a user to authenticated him or herself in response to voting, typing in a comment, accessing images, or accessing patient charts. The AJAX implementation provides for the rendering of all the content and activity related features in one web page, and in response to the validation of the user the content and or activity related material can be rendered in the same page without requiring it to be reloaded.

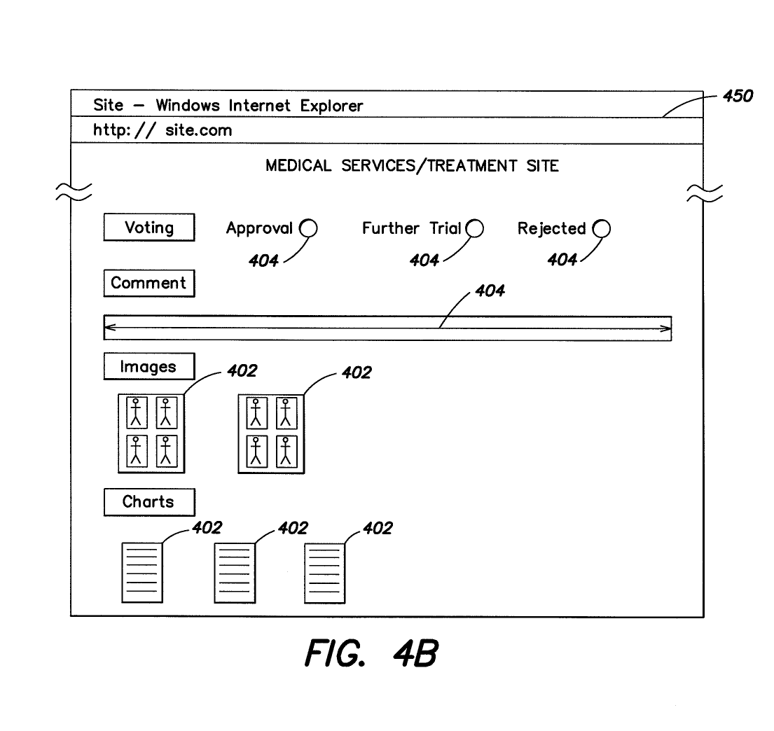

With respect to FIG. 5, interface 500 is shown. Interface 500 is an embodiment of an interface used as a Feedback Mechanism Interface. As shown interface 500 provides for a user to enter their name (502), their user name (504) and select a submission button (YES—506) for reporting unauthorized access. Button 508 is also provided should interface 500 be reached in error.

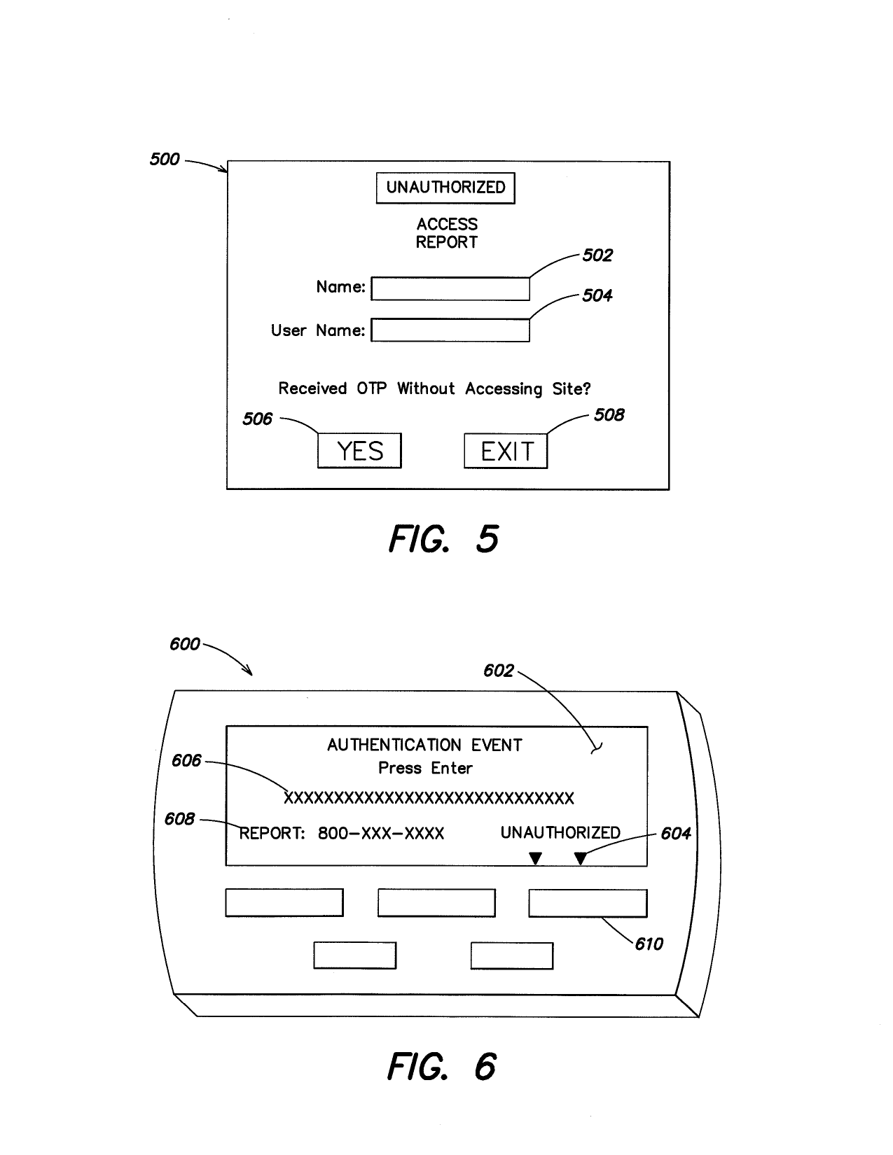

With respect to FIG. 6, shown is an exemplary implementation of a pager 600 associated with a user. Pager display window 602, shows an exemplary page display, where the pager 600 has received the transmission of authorization information in accordance with the teachings of the present invention. Display window 602 shows exemplary authorization information 606 that a user enters into the environment he or she is navigating. Also included in the transmission of authorization information shown, is an optional display of a phone number 608 used as part of the feedback reporting mechanism. As an optional alternative, 604 is displayed to indicate in the case of a two-way enabled pager, button 610 may be selected to reply to the transmission of the authorization information to report unauthorized activity. In the optional alternative, selection of button 610 may cause a second image to display in display window 602, asking the user to confirm report of unauthorized access (not shown).

Various embodiments according to the present invention may be implemented on one or more computer systems. These computer systems may be, for example, general-purpose computers such as those based on Intel PENTIUM-type processor, Motorola PowerPC, AMD Athlon or Turion, Sun UltraSPARC, Hewlett-Packard PA-RISC processors, or any other type of processor. It should be appreciated that one or more of any type computer system may be used to facilitate the use of authorization event triggers according to various embodiments of the invention. Further, the system may be located on a single computer or may be distributed among a plurality of computers attached by a communications network.

A general-purpose computer system according to one embodiment of the invention is configured to perform any of the described functions, including but not limited to providing a secure environment, permitting user access in response to submitting authentication information, providing for navigation of both secure and unsecured sites, establishing at least one event trigger that generates an authentication request, providing for generation of authentication information, providing for transmission of authentication information to a device associated with a user, and providing for the verification of submitted authentication information, among others. It should be appreciated, however, that the system may perform other functions, including providing access to a information brokerage environment, providing access to a medical services environment, providing access to tickets in associated the information brokerage environment, provide access to medical histories, charts, laboratory reports, and activities associated with rendering medical care, as well as employing authorization event triggers in conjunction with both environments, etc. Additional functions may also include providing for a Provider to establish specific event triggers linked to particular content in an environment, providing for a provider to establish event triggers linked to specific activities in an environment, where the specific activities may include notating a patient's chart, requesting laboratory reports, requesting laboratory work, writing prescriptions, voting, bidding, submitting comments, etc., the particular functions may occurs in a specific environment for example an IBE, or a medical treatment/services environment, and the invention is not limited to having any particular function or set of functions or any particular environment and may include multiple environments.

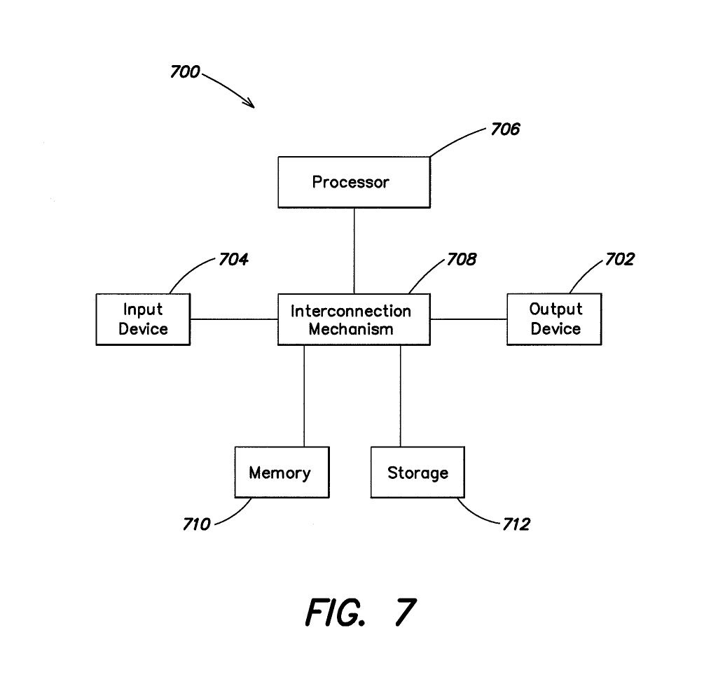

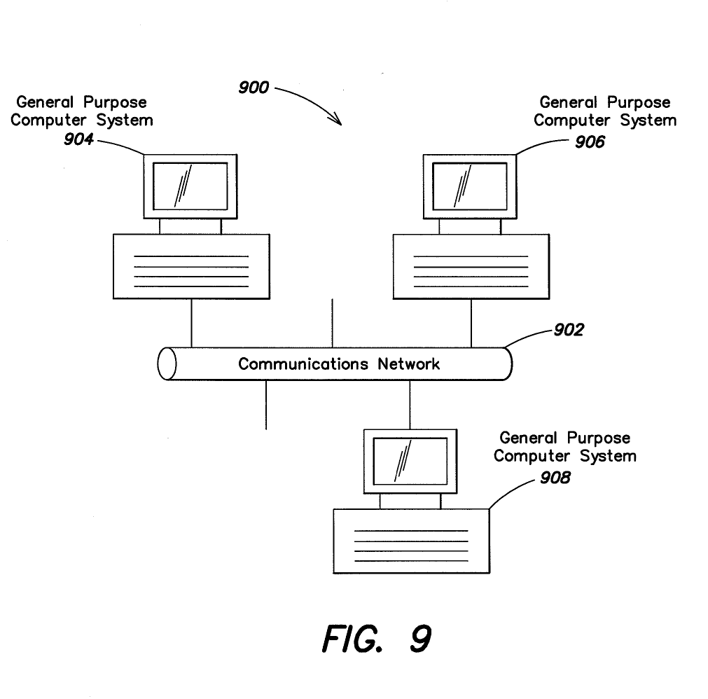

FIG. 7 shows a block diagram of a general purpose computer system 700 in which various aspects of the present invention may be practiced. For example, various aspects of the invention may be implemented as specialized software executing in one or more computer systems including general-purpose computer systems 904, 906, and 908 communicating over network 902 shown in FIG. 9. Computer system 700 may include a processor 706 connected to one or more memory devices 710, such as a disk drive, memory, or other device for storing data. Memory 710 is typically used for storing programs and data during operation of the computer system 700. Components of computer system 700 may be coupled by an interconnection mechanism 708, which may include one or more busses (e.g., between components that are integrated within a same machine) and/or a network (e.g., between components that reside on separate discrete machines). The interconnection mechanism enables communications (e.g., data, instructions) to be exchanged between system components of system 700.

Computer system 700 may also include one or more input (704)/output (I/O) devices (702), for example, a keyboard, mouse, trackball, microphone, touch screen, a printing device, display screen, speaker, etc. Storage 712, typically includes a computer readable and writeable nonvolatile recording medium in which signals are stored that define a program to be executed by the processor or information stored on or in the medium to be processed by the program.

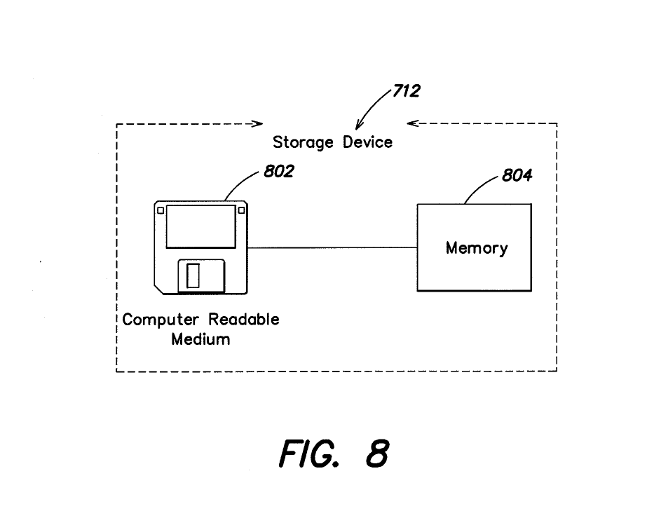

The medium may, for example, be a disk 802 or flash memory as shown in FIG. 8. Typically, in operation, the processor causes data to be read from the nonvolatile recording medium into another memory 804 that allows for faster access to the information by the processor than does the medium. This memory is typically a volatile, random access memory such as a dynamic random access memory (DRAM) or static memory (SRAM).

Referring again to FIG. 7, the memory may be located in storage 712 as shown, or in memory system 710. The processor 706 generally manipulates the data within the memory 710, and then copies the data to the medium associated with storage 712 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 700 is shown by way of example as one type of computer system upon which various aspects of the invention may be practiced, it should be appreciated that aspects of the invention are not limited to being implemented on the computer system as shown in FIG. 7. Various aspects of the invention may be practiced on one or more computers having a different architectures or components than that shown in FIG. 7.

Computer system 700 may be a general-purpose computer system that is programmable using a high-level computer programming language. Computer system 700 may be also implemented using specially programmed, special purpose hardware. In computer system 700, processor 706 is typically a commercially available processor such as the well-known Pentium class processor available from the Intel Corporation. Many other processors are available. Such a processor usually executes an operating system which may be, for example, the Windows-based operating systems (e.g., Windows Vista, Windows NT, Windows 2000 (Windows ME), Windows XP operating systems) available from the Microsoft Corporation, MAC OS System X operating system available from Apple Computer, one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the invention may be programmed using an object-oriented programming language, such as Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various aspects of this invention can be implemented by one or more systems similar to system 700. For instance, the system may be a distributed system (e.g., client server, multi-tier system) comprising multiple general-purpose computer systems. In one example, the system includes software processes executing on a system associated with a user (e.g., a client computer system). These systems may permit authorization of a user locally or may permit remote authorization of a user, authorization occurs in response to authorization event triggers as discussed above, among other functions. There may be other computer systems that perform functions such as providing a secure environment, permitting user access in response to submitting authentication information, providing for navigation of both secure and unsecured sites, establishing at least one event trigger that generates an authentication request, providing for generation of authentication information, providing for transmission of authentication information to a device associated with a user, providing for the verification of submitted authentication information, providing access to a information brokerage environment, provide access to a medical services environment, providing access to tickets associated with the information brokerage environment, provide access to medical histories, charts, laboratory reports, and activities associated with rendering medical care, as well as employing authorization event triggers in conjunction with both environments, etc. Additional functions may also include providing for a Provider to establish specific event triggers linked to particular content in an environment, providing for a provider to establish event triggers linked to specific activities in an environment, where the specific activities may include notating a patient's chart, requesting laboratory reports, requesting laboratory work, writing prescriptions, voting, bidding, submitting comments, etc. These systems may be distributed among a communication system such as the Internet. One such distributed network, as discussed below with respect to FIG. 9, may be used to implement various aspects of the invention.

FIG. 9 shows an architecture diagram of an example distributed system 900 suitable for implementing various aspects of the invention. It should be appreciated that FIG. 9 is used for illustration purposes only, and that other architectures may be used to facilitate one or more aspects of the invention.

System 900 may include one or more general-purpose computer systems distributed among a network 902 such as, for example, the Internet. Such systems may cooperate to perform functions related to user authentication. In an example of one such system for user authentication, one or more users is authenticated over one or more client computer systems 904, 906, and 908 through which authentication requests are delivered in order to authentication the one or more users. It should be understood that the one or more client computer systems 904, 906, and 908 may also be used to access, for example, a secure or unsecured site that includes authorization event triggers based on various aspects of the invention as well as enabling the remote access to content and activities that may be protected by authorization events defined by a provider of the secure or unsecured site. In one example, user interface with the system via an Internet-based interface.

In one example, a system 904 includes a browser program such as the Microsoft Internet Explorer application program through which one or more websites may be accessed. Further, there may be one or more application programs that are executed on system 904 that perform functions associated with user authentication. System 904 may include one or more local databases including, but not limited to, information relating to user authentication, information relating to authorization event triggers, information relating to transmission to user associated devices, information relating to generation of authentication information, as well as information related to security feedback mechanisms.

Network 902 may also include, as part of the system for authenticating user(s) one or more server systems, which may be implemented on general purpose computers that cooperate to perform various functions of the system for authenticating user(s) including providing a secure environment, permitting user access in response to submitting authentication information, providing for navigation, establishing at least one event trigger that generates an authentication request, providing for generation of authentication information, providing for transmission of authentication information to a device associated with a user, and providing for the verification of submitted authentication information. System 900 may optionally provide for a feedback mechanism for reporting unauthorized activity and/or the receipt of authentication information by the authorized user at a time when the authorized user was not accessing the site. System 900 may execute any number of software programs or processes and the invention is not limited to any particular type or number of processes. Such processes may perform the various workflows associated with the system for authenticating user(s).

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for authentication of a user employing triggers for authorization events, the method comprising:
providing a secure environment for a user to access;
permitting the user to access the secure environment in response to the user submitting authentication information;
providing for the authenticated user to navigate within the secure environment;
establishing at least one authorization event trigger that generates an authentication request in the secure environment;
providing for generation of authentication information in response to an authorization event trigger;
providing for transmission of the authentication information to a device associated with the user; and
providing for verification of submitted authentication information.

2. The method of claim 1, wherein the act of providing for transmission of the authentication information comprises providing for transmission of the authentication information over a paging network.

3. The method of claim 2, wherein the act of providing for transmission of the authentication information comprises transmitting the authentication information as a page to a pager.

4. The method of claim 1, wherein the device associated with the user is a liability insured device.

5. The method of claim 1, wherein the at least one authorization event trigger comprises at least one of a content trigger and an activity trigger

6. The method of claim 1, wherein the act of establishing at least one authorization event trigger further comprises defining at least one of an activity and content associated with the secure environment.

7. The method of claim 6, wherein the at least one of an activity and content associated with the secure environment comprises at least one of private information of a third party, licensed activity, reputational related activity, opinion information, reputation information, voting, ticket generation, notating records, bidding, information protected by information privacy law, information subject to contractual privacy obligation, information subject to public safety, information subject to liability of the provider, and information associated with a high value transaction.

8. The method of claim 1, further comprising an act of providing a feedback mechanism for an authorized user.

9. The method of claim 1, further comprising an act of tracking unauthorized access by tracking at least one of keystroke activity of the unauthorized user, communication protocol information generated between unauthorized user and the secure environment, and redirecting unauthorized user to trace unauthorized access.

10. In an information brokering service environment, a method for authentication of a user employing triggers for authorization events, the method comprising:
providing for the user to navigate the information brokering service environment;
establishing at least one authorization event trigger that generates an authentication request associated with the information brokering service environment;
providing for generation of authentication information in response to an authorization event trigger;
providing for transmission of the authentication information to a device associated with a user; and
providing for the verification of user submitted authentication information against the generated authentication information.

11. The method of claim 10, wherein the act of providing for transmission of the authentication information comprises transmitting the authentication information as a page to a pager.

12. The method of claim 10, wherein the device associated with the user is a liability insured device.

13. The method of claim 10, wherein the at least one authorization event trigger comprises at least one of an activity trigger and a content trigger.

14. The method of claim 10, wherein the act of establishing at least one authorization event trigger further comprises defining at least one of activity and content associated with the information brokerage environment, and wherein the at least one of activity and content associated with the information brokering service environment comprises at least one of private information of a third party, licensed activity, reputational related activity, opinion information, reputation information, voting, ticket generation, notating records, bidding, information protected by privacy law, information subject to contractual privacy obligation, information subject to public safety, information subject to liability of the provider, and information associated with a high value transaction.

15. The method of claim 10, further comprising an act of providing a feedback mechanism for an authorized user.

16. The method of claim 10, further comprising an act of tracking unauthorized access by tracking at least one of keystroke activity of the unauthorized user, communication protocol information generated between unauthorized user and the secure environment, and redirecting unauthorized user to trace unauthorized access.

17. In a medical services and treatment environment, a method for authentication of a user employing triggers for authorization events, the method comprising:
providing for the user to navigate the medical services and treatment environment;
establishing at least one authorization event trigger that generates an authentication request associated with the medical services and treatment environment;
providing for generation of authentication information in response to an authorization event trigger;
providing for transmission of the authentication information to a device associated with a user; and
providing for the verification of user submitted authentication information.

18. The method of claim 17, wherein the act of providing for transmission of the authentication information comprises providing for transmission of the authentication information over a paging network.

19. The method of claim 18, wherein the act of providing for transmission of the authentication information comprises transmitting the authentication information as a page to a pager.

20. The method of claim 17, wherein the device associated with the user is a liability insured device.

21. The method of claim 18, wherein the at least one authorization event trigger comprises at least one of a content trigger and an activity trigger.

22. The method of claim 18, wherein the act of establishing at least one authorization event trigger further comprises defining at least one of an activity and content associated with the secure environment.

23. The method of claim 22, wherein the at least one of an activity and content associated with the medical services and treatment environment comprises at least one of private information of a third party, licensed activity, reputational related activity, opinion information, reputation information, voting, ticket generation, notating records, bidding, information protected by privacy law, information subject to contractual privacy obligation, information subject to public safety, information subject to liability of the provider, and information associated with a high value transaction.

24. The method of claim 17, further comprising an act of providing a feedback mechanism for an authorized user.

25. The method of claim 19, further comprising an act of tracking unauthorized access by tracking at least one of keystroke activity of the unauthorized user, communication protocol information generated between unauthorized user and the medical services and treatment environment, and redirecting unauthorized user to trace unauthorized access.
